(19) United States
(12) Patent Application Publication
(10) Pub. No.: US 2022/0297459 A1
(43) Pub. Date: Sep. 22, 2022

(54) Method for Decorating a Packaging Box

(71) Applicant: AGFA NV, Mortsel (BE)

(72) Inventor: Luc De Roeck, Mortsel (BE)

(73) Assignee: AGFA NV, Mortsel (BE)

(21) Appl. No.: 17/619,828

(22) PCT Filed: Jun. 16, 2020
(86) PCT No.: PCT/EP2020/066554

§ 371 Date: Dec. 16, 2021

(30) Foreign Application Priority Data
Jun. 17, 2019 (EP) 19180589.4

(51) Int. Cl. B41M 5/00; B41J 11/00

(52) U.S. Cl. CPC B41M 5/0088; B41J 11/001; B41J 11/007; B41J 11/0085

(57) ABSTRACT

A method for decorating an unassembled packaging box (300) comprising the following steps: a) holding by vacuum suction the unassembled packaging box with its side to an air-permeable support (200) onto a vacuum support of an inkjet printer (100); and b) inkjet printing an image on the unassembled packaging box wherein the air-permeable support 200) is partly covered by said unassembled packaging box wherein the air-permeable support (200) comprises a fibrous layer in contact with the side of the unassembled packaging box (300) and wherein the fibrous layer is an unwoven fabric.

### TECHNICAL FIELD

The present invention relates to the manufacturing of decorated packaging boxes for e-commerce systems.

### BACKGROUND ART

The role of e-commerce is becoming more and more significant in retail. Customers are increasingly placing orders online from the comfort of their homes via a retailer's website. The ordered merchandise is then put into a packaging box and delivered by a delivery vehicle to the customer's residence or another desired address. In this manner, a customer can conveniently make a purchase without having to devote time and effort to physically travel to a store to look for the desired merchandise, if available.

Merchandise articles come in different dimensions requiring the package shipping center of the e-commerce facility to have a large stock of packaging boxes in different sizes. This does not only come at an economical cost, but also causes logistic problems inside the shipping center. Furthermore, even with a large variety in predetermined dimensions of packaging boxes, significant free space generally remains in the packaging box containing one or more merchandise articles. This free space, frequently filled up with a cheap filler material, results in inefficient shipping as fewer packaging boxes can be loaded into a delivery vehicle.

For reducing the packaging costs, machines have been developed to manufacture customized packaging boxes, so-called ‘box-on-demand’ systems. Such ‘box-on-demand’ packaging machines are exemplified by WO 2016/203343 A (PANOTEC) and EP 2697124 A (BOSCH).

However, these ‘box-on-demand’ systems do not solve all the logistics problems in a shipping center. Another problem often encountered is a package with a missing label, a package with a damaged or unreadable label and even mislabeled packages.

Also the competition between e-commerce companies is fierce and these companies are investigating ways to enhance customer experience and customer engagement.

Accordingly, it is desirable to develop an approach in which e-commerce companies can deliver packages in a more efficient and economical way, while at the same time having the option to enhance customer experience and customer engagement. Hereby it is found that the handling of unassembled packaging box on a support of an inkjet printer is not easy due to forces between intertwined fibres and forces between fluted sheet and liner of said unassembled packaging box. Said forces cause wrinkles or sudden pop-ups, even while printing, which result in regular collisions with the print heads of said printer. Enlarging the throw distance may overcome said collisions but this results in blurry inkjet printed images. A vacuum support may help flattening the unassembled packaging box but said forces results in uncontrolled holding of said unassembled packaging box against the vacuum support, especially at the edges and the flaps of said unassembled packaging box.

Using a sticky non-permeable support for adhering the unassembled packaging box and wherein said sticky non-permeable support is hold onto a vacuum support of a printer is a known method of supplying unassembled packaging box in an inkjet printer. But said stickiness makes it hard for (re)positioning said unassembled packaging box on said non-permeable support and the unassembled packaging box has a contamination of glue after removing the unassembled packaging box from said non-permeable support, which have to be cleaned in an extra step. Also the sticky layer from said non-permeable support have to be renewed or said non-permeable support is a consumable that may be reused only once or maximum two times, which results in manufacturing waste.

Hence, there is a need for obtaining a more efficient and faster method of high quality decorating unassembled packaging box wherein the method avoids collisions against expensive print heads.

### SUMMARY OF INVENTION

In order to overcome the problems described above, preferred embodiments of the present invention have been realised with a method for decorating an unassembled packaging box according to claim 1.

It was found that by digitally printing on an unassembled packaging box a customized packaging box from packaging material solves many logistics problems, while at the same time obtaining a cost reduction due to less stock of the packaging material, less ink and smaller transportation costs.

These and other objectives will become apparent from the detailed description hereinafter.

The present invention is a method for decorating an unassembled packaging box comprising the following steps:

a) holding by vacuum suction the unassembled packaging box with its side to an air-permeable support onto a vacuum support of an inkjet printer; and
b) inkjet printing an image on the unassembled packaging box wherein the air-permeable support is partly covered by said unassembled packaging box. The unassembled packaging box has in the present invention a side, which is in contact with the air-permeable support and an opposite side whereon an image shall be inkjet printed. Said opposite side is further also called an other side or printing side from said unassembled packaging box. Typically said unassembled packaging box has one or more die-lines to make it possible to assembled into a packaging box.

A support is air-permeable if the air-permeability is larger than 15 L/(dm²×min) at 200 Pa difference pressure. The unassembled packaging box is in the present invention made of packaging material such as corrugated cardboard.

The unassembled packaging box becomes by the present invention flat for printing and also edges of said unassembled packaging box, becomes fixed to said air-permeable support whereby collisions against print heads of said inkjet printer are prevented. Especially when said unassembled packaging box comprises a panel or a plurality of panels as edges of said unassembled packaging box. Said panel preferably has than an die-line for easy folding and assembling, thus a pivotable flap. The unassembled packaging box is sometimes called an unfolded packaging box. It is namely ready for folding to a packaging box. The present invention prints on said unassembled packaging box before the assembling to a packaging box.

An unassembled packaging box is cutted from packaging materials such as corrugated cardboard in a certain folding scheme. The pre-mentioned panels are used for forming the sides of the packaging box and/or for fixing and/or folding said sides to a three-dimensional packaging box. Said panels are also called flaps. Preferably said panel comprises one or more die-lines for easy folding the box. Not only at said flaps it is difficult to hold down the unassembled packaging box flat while printing. An unassembled packaging box may comprise also one or moving box handles for easy moving an assembled packaging box. At said moving box handles, the present invention also guarantees a good fixing to said air-permeable support.

The air-permeable support becomes sandwiched by vacuum suction between the side and the vacuum support of the inkjet printer; wherein the unassembled packaging box partly covering said air-permeable support. The present invention is especially advantageous when said unassembled packaging box is irregular shaped or having an edge with a sharp corner or having minimum as edge a flap having a die-line for folding said flap.

The fibrous layer is preferably an unwoven fabric, more preferably felt and most preferably polyester felt. A polyester felt may be blended with other materials such as wool.

The fast holding and easy fixing of the unassembled packaging box by the present invention can be even more efficient wherein the air-permeable support comprises a register mark for arranging the unassembled packaging box or more than one unassembled packaging boxes on said support and/or comprising an additional step prior to step b) applying register means on the air-permeable support for aligning the unassembled packaging box on said support.

Said register mark may be a ruler, a grid of n×m small squares or one or more small lines for easy registering said unassembled packaging box or even more than one unassembled packaging box. Said mark may comprise an identification code or means for calculating distances. Said register means is for example a registration pin or registration bar.

Due to forces between intertwined fibres of the unassembled packaging box it may happen that a hump or curl occur before printing; Said hump or curl have to be flattened before printing onto the vacuum support. This may be done by hand or more preferably by a flattening device, such as a squeegee or a flat iron.

Sometimes the unassembled packaging box is quite stiff; which may be softened by humidifying the unassembled packaging box before applying the unassembled packaging box on the air-permeable support. Another way of solving this is an additional step, prior to step a):
applying an adhesive on the side and/or the air-permeable support for making up a sticky layer between said side and said air-permeable support. Said other way is not preferred because glue remains on the side of the unassembled packaging box. Said remaining have to be washed off as extra step. Preferably the air-permeable support of the present invention does not have said sticky layer. Said sticky layer is preferably formed during step a) and b) for example by a heating step of the air-permeable support and/or unassembled packaging box if a heat-sensitive adhesive is used. The adhesive is in the present invention between the side and the air-permeable support when said side and said support are supplied together.

The present invention may be improved even more for high quality inkjet images wherein the unassembled packaging box has also an other side and wherein the other side comprises a base coat and wherein the method comprises an additional step, after step b):
applying a top coat on the printed unassembled packaging box and optionally heat pressing an assembly from said base coat, said unassembled packaging box, said printed image, and said top coat. The image is then printed on said base coat. In a preferred embodiment the air-permeable support may also be heat pressed together with previous assembly as support.

With the present invention also the distance of ‘thrown’ droplets from print head towards the unassembled packaging box for printing the image can be shortened. Said throw distance is preferably lower than 4 mm and more preferably between 0.1 mm and 3 mm. Smaller the throw distance, better the image quality.

These and other objects of the present invention will become apparent from the detailed description hereinafter.

### BRIEF DESCRIPTION OF DRAWINGS

FIG. 1 illustrates the method of the present invention with a Jeti TAURO™ of AGFA NV as inkjet printer. Said printer is a wide-format inkjet printer (100) and it comprises a vacuum belt (not visible). The operator prepares and supplies in FIG. 1 air-permeable supports (200) having unassembled packaging boxes (300) on said supports.

FIGS. 2 and 3 illustrate a top view and cross-section of an air-permeable support (200) which supports an unassembled packaging box (300) and at the right side of the way of folding the packaging box (310). Said support is carried on a vacuum support (150) of an inkjet printer (not visible). The part of the unassembled packaging box (300) has a side (370) and an other side (350). The air-permeable support (200) in FIG. 2 comprises a fibrous layer (250) in contact with said side (370). FIG. 3 the air-permeable support (200) is a fibrous layer (250) in contact with said side (370). The sides of the unassembled packaging box in FIG. 2 and FIG. 3 are liners and in between there is a fluted sheet, which is marked as a wavy line. The other side (350) is the side whereon the image is printed.

FIGS. 4 to 7 show the several steps of the present invention for manufacturing an inkjet printed packaging box (FIG. 7, 8) with a certain length (L); width (W) and height (H).

FIG. 4 illustrates a top view of an air-permeable support (200) which supports an unassembled packaging box (300).

FIG. 5 illustrates the inkjet printing of warning pictograms (4), a machine readable code (5) and a company logo (6) by a single pass inkjet printer 3 onto specific areas of the unassembled packaging box (300).

FIG. 6 illustrates the result after inkjet printing said warning pictograms (4), machine readable code (5) and company logo (6) and after removing the unassembled packaging box (300) from the air-permeable support (200).

FIG. 7 illustrates the result after assembling said inkjet printed unassembled packaging box wherein the flaps at the upper-side are still open.

FIG. 8 illustrates the composition of a packaging material suitable for the invention formed by gluing a flut sheet 10 with glue 12 to a paper inner liner 9 and a paper outer liner 11.

FIG. 9 illustrates how three unassembled packaging boxes (300) with several length, width and height (Lₓ, Wₓ, Hₓ; x=1,2,3) are arranged on the air-permeable support (200) in order to enhance the production timing.

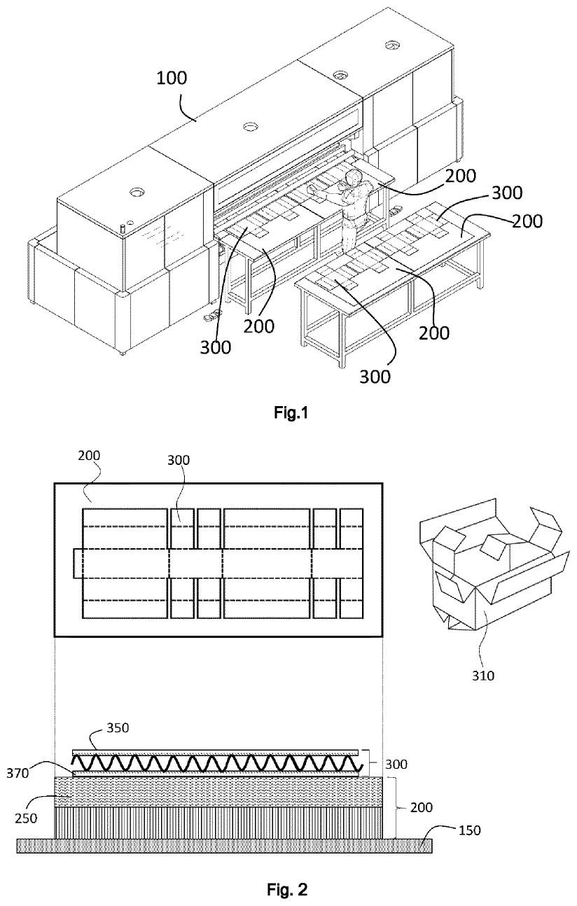

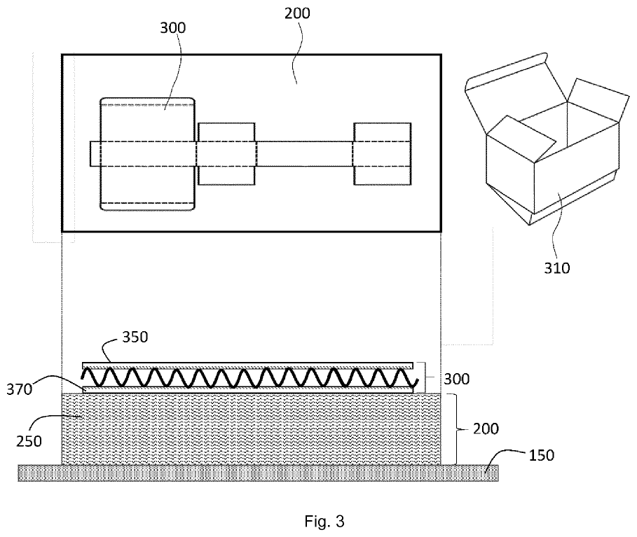

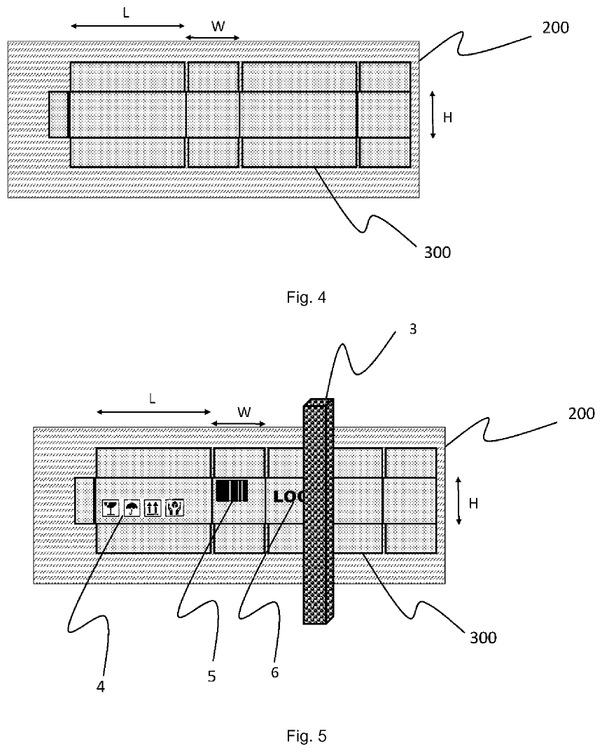

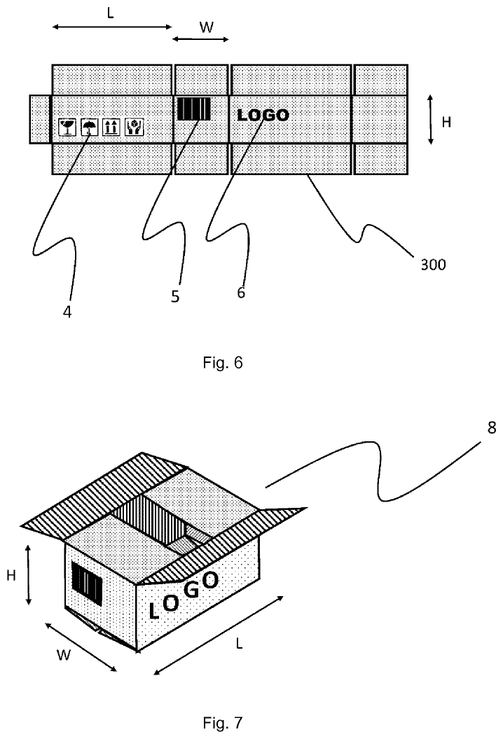

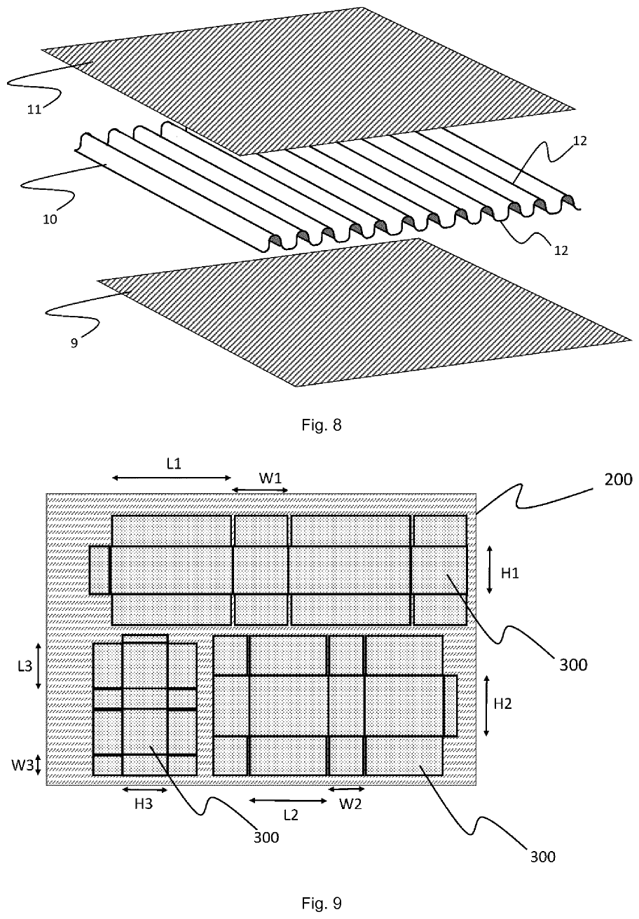

### DESCRIPTION OF EMBODIMENTS

To avoid collisions of unassembled packaging box in an inkjet printer the present invention comprises a method for decorating an unassembled packaging box comprising the following steps:

a) holding by vacuum suction the unassembled packaging box with its side to an air-permeable support onto a vacuum support of an inkjet printer; and
b) inkjet printing an image on the unassembled packaging box wherein the air-permeable support is partly covered by said unassembled packaging box.

The air-permeable support may be reused for following print jobs on an other unassembled packaging box. The unassembled packaging box is preferably an unassembled box for a customized packaging box. Said customized packaging box is preferably manufactured by an automated packaging system which is specifically designed for warehouse dispatch fulfilment, where random, single, multiple, loose or grouped items or goods need to be packaged automatically into multiple footprint boxes for dispatch. Said packaging system makes it possible to ensuring smallest volumetric dimensional weight (DIM weight) possible, without compromising security which is typically used in packaging-on-demand.

The unassembled packaging box may first be supplied on said air-permeable support and supplied onto the vacuum support if said air-permeable support is not a belt. Said order of steps is an advantage because the first step can be done in parallel, so called offline, while printing another unassembled packaging box onto another air-permeable support.

Or the air-permeable support may first be supplied onto the vacuum support and afterwards the unassembled packaging box may be supplied on said air-permeable support.

In the present invention the air-permeable support becomes sandwiched by vacuum suction between the unassembled packaging box and the vacuum support of the inkjet printer wherein said unassembled packaging box partly, thus not entirely, covers said air-permeable support for better adhering of the edges of said unassembled packaging box. On the assembly, formed by said unassembled packaging box and said air-permeable support, still part of the air-permeable support is visible.

It is found that if the air-permeable support is entirely covered by the unassembled packaging box, the edges of the unassembled packaging box are not held well against said air-permeable support.

### Packaging Box

The packaging box is preferably a customized packaging box which is used in the field of e-commerce. Said customized packaging box is preferably made by an automatic packaging system, sometimes called box-on-demand system. The present invention prevents especially edge curling or suddenly moving up panels/flaps/interlocks of an unassembled packaging box, which may touch a print head of the inkjet printer or misalign said print head.

However, any packaging design, such as corrugated box design is possible, the packaging box is preferably a box style as provided by the European Federation of Corrugated Board Manufacturers (FEFCO) and more preferably a slotted-type box and most preferably a regular slotted container (RSC). The packaging box is preferably selected from a slotted-type box (03XX-XXXX design code of FEFCO), folder-type box (04XX-XXXX design code of FEFCO), slide-type box (05XX-XXXX design code from FEFCO), rigid-type box (06XX-XXXX design code from FEFCO) and interior fitments (09XX-XXXX design code of FEFCO). The unassembled packaging box preferably comprises a flap for interlocking panels when folding and/or assembling the packaging box.

The closure of a packaging box is preferably done by hot gluing; cold gluing; taping; interlocking and/or stitching.

The panels of the packaging box may be joined together after the folding and/or assembling of the unassembled packaging box for example by glue, tape or a stitch or interlocking. But some panels of the unassembled packaging box may also already be joined by glue, tape or a stitch together for fast folding the unassembled packaging box but the unassembled packaging box still remains flat on the air-permeable support. It has then panels on top of each other, such as ready-glued packaging box also called ready-glued cases.

The present invention is preferably included in a manufacturing method of a decorated packaging box comprising the additional step:
cutting packaging material according a cutting scheme of a design of a packaging box to form an unassembled packaging box;
the method according to claim 1 and its preferred embodiments;
assembling the decorated unassembled packaging box to a packaging box;
optionally hot or cold gluing; taping; interlocking and/or stitching for closure the packaging box. The assembling step may comprise a folding step.

### Adhesives

An adhesive may be used for attaching an unassembled packaging box with its side to an air-permeable support. The adhesive may be applied to said air-permeable support, to said unassembled packaging box or to both of them.

Any adhesive known in the art can be used in the present invention, going from classical known adhesives to biomimic based adhesives. Repositionable adhesives are preferred, as they facilitate the process for ensuring that the leather is attached completely flat on the carrier causing no collision with the inkjet print heads. Heat sensitive glue is preferred because there is already light tackiness at room temperature and a high tackiness already from 30° C.

Bio-inspired reversible adhesives have been described by del Campo and Fernández-Blázquez (Biomimetic Approaches for Biomaterial Development, chapter 11, ed. João F. Mano, Wiley-VCH Verlag GmbH& Co. KGaA, first edition, 2012).

Adhesives are known in different fields of technology such as textile printing, where water gluing and dry bonding approaches are used. Within dry bonding approaches, both permanent and thermoplastic adhesives are known in the art. Adhesives for textile printing are disclosed in Ullmans Encyclopädie der technischen Chemie, 4. Auflage, Band 23, 76-77 (VERLAG CHEMI, WEINHEIM).

In the present invention, pressure sensitive adhesives are a particular preferred type of adhesives. Removable pressure sensitive adhesives are known from applications such as the Post-It™ notes from 3M.

Preferred polymers for pressure sensitive adhesives are selected from the group consisting of polyacrylates, silicone polymers, polydienes or copolymers thereof such as natural rubber and styrene-butadiene type of rubbers and block copolymers of styrene and a diene. Typical formulations of pressure sensitive adhesives further contain tackifying resins to tailor the properties towards the application. Pressure sensitive adhesives further can contain additives such as waxes, plasticizers and anti-oxidants.

The pressure sensitive adhesive is applied on a surface from water, a solvent or as a hot melt adhesive. Hot melt adhesives and water borne adhesives are preferred. Water borne adhesives are particularly preferred. Water borne pressure sensitive adhesives are emulsion-based and have been described in detail by Jovanović and Dubé (Journal of Macromolecular Science, Part C-Polymer Reviews, C44(1), 1-55 (2004)).

Suitable adhesives are available from KIWO (KISSEL+WOLF GmbH).

There is no limitation on the way of applying the adhesive to a surface, which may be e.g. by coating or by spraying. A commercial example of a suitable spray adhesive is the 3M™ Repositionable 75 Spray Adhesive. Spray adhesives are also known as aerosol adhesives.

Use of an adhesive has also some disadvantages such as glue remaining on the side or air-permeable support, need of an extra pressure device . . . . But it is found when using heat sensitive glue, such as KIWOTEX TDK 35L from KIWO™, the contamination of glue on the side is very limited after step of inkjet printing. But preferably the air permeable support has no sticky layer as described above for a better adhering of the unassembled packaging box.

### Air Permeable Supports

The air-permeable support is in the present invention larger than the unassembled packaging box and preferably flat. Said unassembled packaging box covers partly said support to have good adherence at the edges of said unassembled packaging box. When said support is even sized than said unassembled packaging box and said unassembled packaging box is fully covering said support, an edge of said unassembled packaging box can crimp (wavy or curl) while applying the vacuum. This may result in a collision against a print head of the inkjet printer.

The air-permeable support comprises one or more fibrous layers wherein the side of the unassembled packaging box preferably is contact with a fibrous layer from said one or more fibrous layers. Said fibrous layer may be coated and/or is an unwoven fabric such as felt. Said felt may be wool felt but preferably it is a polyester felt. Also recycled polyester felt may be used. Polyester felt are most preferred because said felts have a tighter construction and they can be used in operating temperature above 30° C. Polyester felt may be blended with other materials such as wool.

To minimize the vacuum power for the air suction in the present invention the air-permeability of the air-permeable support may be at 200 Pa difference pressure between 30 and 120 L/(dm²×min) preferably between 35 and 90 L/(dm²×min). Said air-permeability can be measured with an AKUSTRON™ air permeability tester which follows industry standards DIN 53887, DIN 53120, ISO9237 and ASTM D 737-96. The air-permeability is thus measured in minutes, abbreviated as ‘min’.

If the air-permeable support comprises a plurality of layers on top of each other, one or more of said layers is a fibrous layer but preferably all layers are fibrous. Said layers needs to be also air-permeable. The air-permeability of said air-permeable support is measured on all said multiple layers. Preferably a first layer from said plurality of layers in contact with the side is having a smaller air-permeability than a second layer, which is a subsequent layer of the first layer. Most preferably a subsequent layer of a layer of the plurality of layers has a higher air-permeability.

For easy handling and having a certain stiffness the air-permeable support the weight is preferably between 0.6 and 2.5 kg/m2. The thickness of said support is than preferably between 1.5 mm and 4 mm, more preferably between 1.5 mm and 3 mm. In a preferred embodiment is the thickness of the air-permeable support twice or more than the thickness of the supported unassembled packaging box but more preferably the thickness of the air-permeable support is not more than 100 times the thickness of the supported unassembled packaging box.

The result of the method obtained in the present invention after inkjet printing is an assembly of a decorated unassembled packaging box wherein its side is attached to an air-permeable support or a preferred air-permeable support as disclosed above. The attachment is preferably caused by vacuum suction through said air-permeably support. Said assembly is an embodiment of the present invention.

The inkjet printed image may be composed of nested sub-images for example one sub-image per flap or panel. Additional cutting or marking after printing may occur after removal of decorated unassembled packaging box from the air-permeable support, but is preferably performed when the decorated unassembled packaging box is still attached to said support. The support comprises then preferably a polyester felt as layer in contact with the side of the unassembled packaging box. Another advantage of the assembly is that it facilitates transport between the printer and the packaging box filler as the assemblies can be easily stapled onto pallets. An identifier, preferably a machine-readable identification code, on the assembly may be used to identify the packaging box filler, thus aiding in the logistic process. Said packaging box filler folds the unassembled packaging box to a packaging box and fills the box with one or more ordered merchandise.

In a preferred embodiment is the air-permeable support a conveyor belt, wrapped around the vacuum support and plurality of pulleys or gliders. Said conveyor belt may be driven by an electric motor for producing a torque to one of said pulleys or conveyed when connected to a vacuum belt as vacuum support. Said last embodiment is highly preferred because the vacuum belt as vacuum support is arranged for printing correctly such as in register and with controlled speed. If the vacuum support is a vacuum table, the air-permeable support has to be stiff and have a low stretchability for printing in register and with controlled speed.

The conveying is preferably with successive distance movements, also called discrete step increments.

The air-permeable support may also be a sheet having one or more fibrous layers and wherein said support has an area larger than the unassembled packaging box.

After the printing-step in the present invention the air-permeable support may be cleaned. This may be performed by a support cleaner comprising:
a receptacle for a cleaning-liquid; and
a cleaning-roll, which is in contact with said air-permeable support;
   wherein the cleaning-roll comprises an elongated carpet fabric which is helical enfold around the cleaning-roll and in which the pile is composed of yarn tufts in loop and/or cut configuration; and wherein the cleaning-roll comprises a helical channel along the length of the enassembled carpet fabric for draining the cleaning-liquid from the cleaning-roll and/or for wetting the cleaning-roll by the cleaning-liquid. If the air-permeable belt is a conveyor belt, said cleaning step may be performed while conveying.

When one or more unassembled packaging boxes are supplied on the air-permeable support, the position may be scanned by a camera-system above said air-permeable support. If said support has a registration mark or registration means or an identification code said scanning can be used for optimizing the supply chain of the decorated unassembled packaging boxes of the present invention. In post-processing of the decorated unassembled packaging box said identification code and positions of said one or more unassembled packaging boxes can be used for example in cutting or heat-pressing or embossing or top-coating said unassembled packaging boxes if they are still on said air-permeable support.

If said air-permeable support has a non-woven fabric as fibrous layer according a preferred embodiment and the post-processing is cutting in the unassembled packaging box wherein it is still on said air-permeable support, the damage of said support by said cutting is minimal. Said non-woven fabric is then preferably polyester felt. Hereby is the air-permeable support reusable for the following print job for decorating unassembled packaging box according the present invention.

In a preferred embodiment the unassembled packaging box comprises a mating hole which matches a head portion of a registration pin supplied to the air-permeable support. Said registration pin is preferably manufactured from a stainless steel, aluminium or plastic material. The mating hole in the unassembled packaging box may be added, preferably near an edge of said unassembled packaging box, by punching said unassembled packaging box for example with a perforator. The edge of an unassembled packaging box is mostly lower in quality, especially when said unassembled packaging box is a half hide or whole hide. The mating hole may also be used in post processing the inkjet printed unassembled packaging box for registration such as further cutting/marking the inkjet printed unassembled packaging box.

To avoid collisions with the print heads of the inkjet printer, a head portion of a register means, such as said registration pin, extends above the unassembled packaging box to a height smaller than the throw distance of said print heads, preferably to a height between 0.1 mm and 3 mm. A bottom portion of said register means may have means for supplying the registration pin into the air-permeable support for example by screwing or drilling or piercing. If said supply of a registration pin is done in the fibrous layer from the previous embodiments, such as unwoven fabric, said pin can easily be removed without leaving a significant hole. Said air-permeable support may be reused several times wherein said pin is (re)positioned more than once.

### Vacuum Support

The vacuum support is preferably a vacuum table, more preferably a vacuum belt wrapped around a vacuum table together with a plurality of pulleys for conveying said vacuum belt and for transporting pieces supported on said vacuum belt.

In the present invention the unassembled packaging box is hold onto the vacuum support by vacuum suction. Said vacuum suction is provided through said vacuum support by a connected vacuum chamber via a plurality of apertures and air channels. The working of a vacuum support, such as vacuum table or vacuum belt are well-known. An example of such vacuum support is disclosed in WO2016/071122 A1 (AGFA GRAPHICS NV).

The vacuum belt preferably comprises a set of air-channels connecting top-surface and bottom-surface of the vacuum belt; and
the set of air-channels couples the air-permeable support to the vacuum belt by vacuum suction in the set of air-channels; and
   wherein the vacuum belt is characterized by having a plurality of dimples at the top-surface wherein each dimple comprises a closed bottom end; and
   wherein the dimple is connected with an air-channel of the set of air-channels to form an air cup and to couple the air-permeable support to the vacuum belt at the dimple by vacuum suction. Said preferred vacuum belt is disclosed in WO 2017/036943 A1 (AGFA GRAPHICS NV).

Another preferred vacuum belt in combination with a vacuum table is disclosed in WO 2018/007121 A1 (AGFA GRAPHICS NV).

In a preferred embodiment wherein the vacuum support is a vacuum belt the air-permeable support is another belt wrapped around said vacuum belt and a plurality of gliders or pulleys. Said specific air-permeable support is conveyed by adhering with air suction to the vacuum belt, while conveying the vacuum belt.

The present invention is tested and validated with the following inkjet printers Jeti Mira and Jeti Tauro H2500, manufactured by Agfa NV and panels and parts of crusted calfskin leather from NUTI IVO. Several types of air-permeable support are tested and validated such as NOVO 25-HC Black and NOVO 40-HC Black from Forbo™.

### Images

There are no real limitations for the image to be digitally printed. A single colour or multiple colours may be used for digitally printing the image. It may be a single image or it may consist of multiple images or sub-images. For example, multiple images may be printed on different unassembled packaging boxes as exemplified in FIG. 9.

The image is preferably digitally printed according to the minimal packaging box dimensions. This way it is prevented that part of the image is not undesirably printed on the air-permeable support.

There is also no real limitation on the content of the image. It may contain decorative features, company logo's, trademarks, photographs, drawings and cartoons and/or information. The information may be human readable, such as text, or it may be machine readable, such as a bar code, or a combination of both.

The image preferably contains one or more machine readable codes, more preferably multiple machine readable codes. These multiple machine readable codes may be different or the same. By using multiple identical machine readable codes on different surfaces of the package, the case where problems occur due to a damaged machine readable code being unreadable can be avoided as usually an intact machine readable code remains readable on a different surface of the package.

There is no restriction on the type of machine readable code or the information it contains. It may be a simple bar code, but it may also be a so-called 2D code. Preferred 2D codes include a QR code, a datamatrix code, a cool-data-matrix code, an aztec code, an upcode, a trillcode, a quickmark code, a shot code, a mcode, and a beetagg.

The information present in the machine code may be the required information or it may be a link for retrieving the information from a source, such as a database or the internet.

There is also no limitation on the content of human readable information, which may include, for example, the destination address of the package, a message for customer engagement, packaging instructions, and a list of merchandise articles packed or to be packed into the packaging box.

The destination address may be to the customer's residence or another desired address. The same information may also be present as such or as a computer link in the machine readable code.

Packaging instructions may be included in the image and can contain, for example, the list of the merchandise articles to be included into the packaging box or instructions on how to arrange the merchandise articles in the packaging box.

The image may also contain a communication for enhancing the customer engagement. Customer engagement is the depth of the relationship a customer has with a company or brand. As the competition between e-commerce companies is strong, these e-commerce companies are constantly investigating ways, other than during the online connection made when ordering the merchandise articles, to enhance customer experience and customer engagement. Today, a packaging box has a rather dull appearance carrying usually only the shipping center company logo. The free space on outer surface of the packaging box could, for example, be sold as advertisement space to the manufacturer(s) of the merchandise articles included in the packaging box. Such advertisement could suggest the sale of, for example, accessories suitable for the ordered merchandise articles. For example, the suggestion of earphones on sale for an ordered smartphone. Advertisements could also be digitally printed for merchandise articles that were looked at, but finally not ordered by the customer.

An image for enhancing customer engagement may also contain a machine readable code, such as a QR-code, which after scanning by the smartphone of a customer leads to a website of the merchandise article manufacturer for enhancing the customer experience.

The free space on the packaging box could also be used to enhance customer engagement. A physical retail shop often provides customer fidelity cards upon sale of merchandise, in order to promote future sale of similar or other merchandise articles at a reduced price. A similar system is today set up by the e-commerce company to offer a discount on a future order of the customer by sending an e-mail to the customer. However, this e-mail is often simply deleted or ended up in the spam-folder. By digitally printing this customer engagement offer on the packaging box, a larger sales effect may be expected, as the customer is often more excited and enthusiastic upon opening the just received packaging box than upon opening an e-mail.

### Base Coats

The base coat applied on the unassembled packaging box, provides a level of image quality commensurate to the luxury aspect of the packaging box as the low viscosity of inkjet inks lets them penetrate rapidly into the unassembled packaging box resulting in a reduced image quality.

The base coat may be applied as a single layer, or may be applied as multiple layers. The multiple layers may even have a different composition for improving properties like adhesion or flexibility.

A cross-linker may be incorporated in the base coat to improve the strength of the base coat and the adhesion to unassembled packaging box.

The base coat is preferably applied by spraying, but may be applied by any coating technique known, such as knife coating, extrusion coating, slide hopper coating and curtain coating. It can be applied prior to attaching the unassembled packaging box to air-permeable support or it may be applied when the unassembled packaging box is already attached to the air-permeable support.

The base coat may be a white base coat to enhance the colour vibrancy of the inkjet printed image.

### Pigmented Inkjet Inks

The one or more pigmented inkjet inks that are inkjet printed may be selected from aqueous pigmented inkjet inks, solvent based pigmented inkjet inks and radiation curable pigmented inkjet inks. However, the one or more pigmented inkjet inks are preferably one or more radiation curable inkjet ink, most preferably one or more UV curable inkjet inks.

The one or more pigmented inkjet inks preferably contain organic colour pigments as they allow for obtaining a high colour gamut on unassembled packaging box. Carbon black and titanium dioxide are inorganic pigments, which can be advantageously used in the present invention for composing black respectively white pigmented inkjet inks.

In a preferred embodiment, the one or more pigmented inkjet inks form a CMYK(W) inkjet ink set.

Pigment particles in inkjet inks should be sufficiently small to permit free flow of the ink through the inkjet-printing device, especially at the ejecting nozzles. It is also desirable to use small particles for maximum colour strength and to slow down sedimentation. The numeric average pigment particle size of an organic colour pigment and an inorganic black pigment is preferably between 0.050 and 1 μm, more preferably between 0.070 and 0.300 μm and most preferably between 0.080 and 0.200 μm.

When using UV curable pigmented inkjet inks, polymerizable compounds and at least one photoinitiator is present in the inkjet ink. The UV curable inkjet ink contains one or more photoinitiators, preferably one or more free radical photoinitiators. A free radical photoinitiator is a chemical compound that initiates polymerization of monomers and oligomers when exposed to actinic radiation by the formation of a free radical. The preparation of pigmented UV curable inkjet inks is well-known to the skilled person. Preferred methods of preparation are disclosed in paragraphs [0076] to [0085] of WO2011/069943 (AGFA).

In a preferred embodiment the image is dried after or while printing the image on the unassembled packaging box, said image is dried by a radiating device. The radiation is preferably performed by using a UV bulb lamp or a plurality of UV light emitting diodes but this generates heat which enhances the chance of curling of unassembled packaging box if supplied directly on the vacuum support. When using the present invention said curling of the unassembled packaging box is solved.

The inkjet printer is a digital printer wherein a non-contact printing technology is used. For having a good image quality, a constant height between a print head and ink-receiver is needed. In the present invention said inkjet printer may be a multi pass inkjet printer but a single pass inkjet printer is preferred.

### Top Coats

A top coat may be applied onto the image and the base coat for enhancing the scratch resistance of the image.

The top coat may be applied as a single layer, or may be applied as multiple layers. The multiple layers may even have a different composition for improving properties like scratch resistance.

The protective top coat may have the same or a similar composition as the base coat. Usually the protective top coat is somewhat optimized according to the packaging application. For example, flexibility does not play an important role for a rectangular box contrary to special designed packaging boxes having irregular shapes or having one or more not-rectangular-shaped sides. The protective top coat may be optimized towards scratch resistance.

A cross-linker may be incorporated in the protective top coat to improve the scratch resistance. Preferred cross-linkers include those mentioned above for the base coat.

The top coat is preferably applied by spraying, but may be applied by the same coating techniques as mentioned above for the base coat.

The top coat is most preferably a transparent top coat, but may be a translucent top coat. By having a transparent top coat, the inkjet printed image is clearly visible through the top coat. By using a translucent top coat, a special aesthetic effect is created.

If a matt top surface is desired for the inkjet printed unassembled packaging box, a matting agent may be included. Any suitable matting agent may be used.

### Packaging Material

There is no restriction on the packaging material as long as it is suitable to manufacture a packaging box from it. Preferred packaging materials are low cost and lightweight. Lightweight packaging material reduces transportation costs and facilitates the handling during delivery to the customer.

A particular preferred packaging material is corrugated card board as it is low cost and lightweight, but also has the benefit that corrugated cardboard boxes are stackable, making them easy to store and transport.

Corrugated cardboard is a packaging material formed by gluing one or more fluted sheets of paperboard (corrugating medium) to one or more flat sheets (called facings) of linerboard. Its comes in four common types: (1) Single face: one fluted sheet glued to one facing (total two sheets). (2) Single wall: one fluted sheet sandwiched between two facings (total three sheets); also called double face or single ply. (3) Double wall: one single-face glued to one single wall so that two fluted sheets are alternatively sandwiched between three flat sheets (total five sheets); also called double cushion or double ply. (4) Triple wall: two single-face glued to one single wall so that three fluted sheets are alternatively sandwiched between four flat sheets (total seven sheets); also called triple ply. The preferred corrugated cardboard in the present invention is single wall or double wall, more preferably single wall corrugated cardboard as this is sufficiently strong and easy to crease. Single face corrugated cardboard generally has insufficient strength to hold the merchandise articles, while triple wall cardboard is often more difficult to crease into a packaging box.

In a preferred embodiment of the present invention the unassembled packaging box is cutted from a corrugated cardboard and more preferred the side, which is in contact with the air-permeable support, is a liner or fluted sheet of said corrugated cardboard.

In another preferred embodiment or combined with previous preferred embodiment the image may be inkjet printed on a liner or fluted sheet of said corrugated cardboard.

The strength of cardboard is important for deliverability, as if merchandise doesn't arrive intact in the hands of your customers, you risk your reputation with them.

The cardboard can come in a variety of constructions, such as e.g. honeycomb cardboard, however for easy creasing preferably a cardboard using a paper fluting medium is used.

Another advantage of a paper based cardboard is the recyclability.

However, for some merchandise it may be sensible to use corrugated plastic. Corrugated plastic is a waterproof, versatile material that can be die cut in the same way as corrugated cardboard. Light weight and durable, this material also has a longer shelf life than cardboard and is better at holding out moisture, such as snow and rain.

1-10. (canceled)

11. A method for decorating an unassembled packaging box, the method comprising:
a) holding by vacuum suction a side of the unassembled packaging box with the side to an air-permeable support which is carried on a vacuum support of an inkjet printer and
b) inkjet printing an image on the unassembled packaging box,
wherein the air-permeable support is partly covered by said unassembled packaging box and comprises an unwoven fabric in contact with the side of the unassembled packaging box.

12. The method of claim 11, wherein the unwoven fabric is a polyester felt.

13. The method of claim 12, wherein the fibrous layer has an air permeability below 90 L/(dm²×min).

14. The method of claim 13, wherein the fibrous layer is in contact with the vacuum support.

15. The method of claim 11, wherein the air-permeable support comprises a register mark for arranging the unassembled packaging box on said support.

16. The method of claim 12, wherein the air-permeable support comprises a register mark for arranging the unassembled packaging box on said support.

17. The method of claim 11, further comprising an additional step prior to step b), the additional step prior to step b) comprising:
applying register means for aligning the unassembled packaging box on the air-permeable support.

18. The method of claim 12, further comprising an additional step prior to step b), the additional step prior to step b) comprising:
applying register means for aligning the unassembled packaging box on the air-permeable support.

19. The method of claim 11, further comprising an additional step prior to step b), the additional step prior to step b) comprising:
flattening said unassembled packaging box onto the air-permeable support.

20. The method of claim 12, further comprising an additional step prior to step b), the additional step prior to step b) comprising:
flattening said unassembled packaging box onto the air-permeable support.

21. The method of claim 11, further comprising an additional step prior to step a), the additional step prior to step a) comprising:
applying an adhesive on the side and/or the air-permeable support.

22. The method of claim 12, further comprising an additional step prior to step a), the additional step prior to step a) comprising:
applying an adhesive on the side and/or the air-permeable support.

23. The method of claim 11, wherein the air-permeable support is a conveyor belt, wrapped around the vacuum support and more than one pulley.

24. The method of claim 12, wherein the air-permeable support is a conveyor belt, wrapped around the vacuum support and more than one pulley.

25. The method of claim 11, further comprising an additional step after step b), the additional step after step b) comprising:
washing the air-permeable support for cleaning said support.

26. The method of claim 12, further comprising an additional step after step b), the additional step after step b) comprising:
washing the air-permeable support for cleaning said support.
